(19) United States
(12) Patent Application Publication
(10) Pub. No.: US 2015/0014414 A1
(43) Pub. Date: Jan. 15, 2015

(54) APPARATUS FOR AND METHOD OF MITIGATING INTERFERENCE BETWEEN PULSED AMBIENT LIGHT AND DATA CAPTURE DEVICES

(71) Applicant: SYMBOL TECHNOLOGIES, INC., Schaumburg, IL (US)

(72) Inventor: JAMES R GIEBEL, Centerport, NY (US)

(73) Assignee: SYMBOL TECHNOLOGIES, INC., Schaumburg, IL (US)

(21) Appl. No.: 14/037,875

(22) Filed: Sep. 26, 2013

Related U.S. Application Data
(60) Provisional application No. 61/845,447, filed on Jul. 12, 2013.

(51) Int. Cl. G06K 7/10

(52) U.S. Cl. CPC G06K 7/10821
USPC 235/455

(57) ABSTRACT

Performance of a laser-based moving beam reader for electro-optically reading a target is enhanced in a venue for transmitting an information signal by pulsing ambient light that interferes with operation of the reader. A converter converts the information signal to an analog information signal. A switching power supply is operatively connected to the converter and to a lighting fixture that emits the ambient light. The switching power supply receives the analog information signal from the converter, generates an output analog control signal from the received analog information signal, and controls the light fixture with the output analog control signal to emit the ambient light in a time-varying, non-pulsed, analog manner to mitigate interference with the operation of the reader.

### CROSS REFERENCE TO RELATED APPLICATION

This application claims priority to U.S. Provisional Patent Application Ser. No. 61/845,447, filed Jul. 12, 2013, the entire contents of which are hereby expressly incorporated herein by reference thereto.

### FIELD OF THE DISCLOSURE

The present disclosure relates to an apparatus for, and a method of, enhancing performance of a data capture device, e.g., a laser-based moving beam reader, operative for electro-optically reading a target, operative in a venue for transmitting an information signal by pulsing ambient light, especially when emitted from fluorescent lamps and light emitting diodes (LEDs) and like lighting fixtures operated at kilohertz frequencies, that interferes with operation of the data capture device.

### BACKGROUND

There are various systems that transmit an information signal by modulating light, typically by pulse width modulation (PWM) that varies the duration of pulses in a pulse train corresponding to the information signal. For example, indoor positioning or communication systems can be used to accurately locate, or communicate with, mobile devices, such as smart phones or cell phones having built-in cameras, in a venue, such as a supermarket, a warehouse, a department store, and the like, having overhead lighting fixtures. The light emitted from the fixtures is operative to both illuminate the venue as ambient light, as well as to transmit an information signal to the cameras in the phones by pulse modulating the light, typically at kilohertz frequencies, to produce pulsed ambient light.

In many such venues, moving laser beam readers or laser scanners have long been used as data capture devices to electro-optically read targets, such as one-dimensional bar code symbols, particularly of the Universal Product Code (UPC) type, printed on labels associated with products. The moving laser beam reader generally includes a housing, a laser for emitting a laser beam having an output power, a focusing lens assembly for focusing the laser beam to form a beam spot having a certain size at a focal plane in a range of working distances relative to the housing, a scan component for repetitively scanning the beam spot over a scan angle across a target in a scan pattern, for example, a scan line or a series of scan lines, across the target multiple times per second, and a photodetector for detecting return light reflected and/or scattered from the target and for converting the detected return light into an analog electrical data signal bearing data related to the target. This analog electrical data signal varies in amplitude as a function of time due to the time-varying return light along each scan line, and varies in frequency as a function of the density of the symbol, as well as the distance at which the symbol is being read. The moving laser beam reader also includes signal processing receiver circuitry including a digitizer for digitizing the variable analog data signal, and a microprocessor for decoding the digitized signal based upon a specific symbology used for the target. The decoded signal identifies the product and is transmitted to a host, e.g., a cash register in a retail venue, for further processing, e.g., product price look-up or product inventorying.

In one advantageous embodiment, during operation of the moving laser beam reader in the aforementioned venue in which light fixtures are emitting pulsed ambient light to transmit the information signal as part of an indoor positioning or communication system, an operator holds the housing in his or her hand, and aims the housing at the target, and then initiates the data capture and the reading of the target by manual actuation of a trigger on the housing. The pulsed ambient light is also concomitantly detected by the photodetector, which generates an analog electrical ambient light signal. When the ambient light is pulsed at kilohertz frequencies, the analog electrical ambient light signal has a relatively large frequency component at kilohertz frequencies, typically anywhere from 30 kHz to 300 kHz. The presence of this relatively large frequency component, however, significantly interferes with the data signal produced by the reader.

Accordingly, there is a need to mitigate such interference caused by such pulsed ambient light and the data capture device, especially a laser-based moving beam reader, to enhance reader performance.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of a venue having an indoor positioning or communication system that transmits an information signal to a mobile device by modulating light emitted from a lighting fixture, and a handheld moving laser beam reader operative at the venue for reading symbol targets, in which an apparatus for mitigating interference between the ambient light and the reader is employed in accordance with the present disclosure.

FIG. 2 is a schematic of an electrical circuit of an apparatus for mitigating interference between the ambient light and the reader in the venue of FIG. 1 in accordance with the present disclosure.

FIG. 3 is a graph depicting signals generated in the circuit of FIG. 2.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One aspect of this disclosure relates to an apparatus for enhancing performance of a data capture device, e.g., a laser-based moving beam reader, operative for electro-optically reading a target, e.g., a bar code symbol, in a venue for transmitting an information signal by pulsing ambient light that interferes with operation of the data capture device. The venue may, for example, be a supermarket, a warehouse, a department store, and the like, and have one or more overhead lighting fixtures and an indoor positioning or communication system operative for accurately locating, or communicating with, mobile devices, such as smart phones or cell phones having built-in cameras, which are present in the venue.

The apparatus includes a converter, e.g., a digital to analog converter, for converting the information signal to an analog information signal, and a switching power supply operatively connected to the converter and to a lighting fixture that emits the ambient light. The switching power supply receives the analog information signal from the converter, generates an output analog control signal from the received analog information signal, and controls the light fixture with the output analog control signal to emit the ambient light in a time-varying, non-pulsed, analog manner to mitigate interference with the operation of the data capture device.

Advantageously, the switching power supply has an input terminal for receiving the analog information signal and a reference voltage, and the output analog control signal increases and decreases in amplitude relative to the reference voltage. The output analog control signal is an electrical current that flows to the lighting fixture, and the switching power supply has a feedback terminal for receiving a current feedback signal from a sensor that detects the electrical current flowing to the light fixture.

A method, in accordance with another aspect of this disclosure, of enhancing performance of a data capture device operative for electro-optically reading a target in a venue for transmitting an information signal by pulsing ambient light that interferes with operation of the data capture device, is performed by converting the information signal to an analog information signal, by generating an output analog control signal from the analog information signal, and by controlling a light fixture that emits the ambient light with the output analog control signal to emit the ambient light in a time-varying, non-pulsed, analog manner to mitigate interference with the operation of the data capture device.

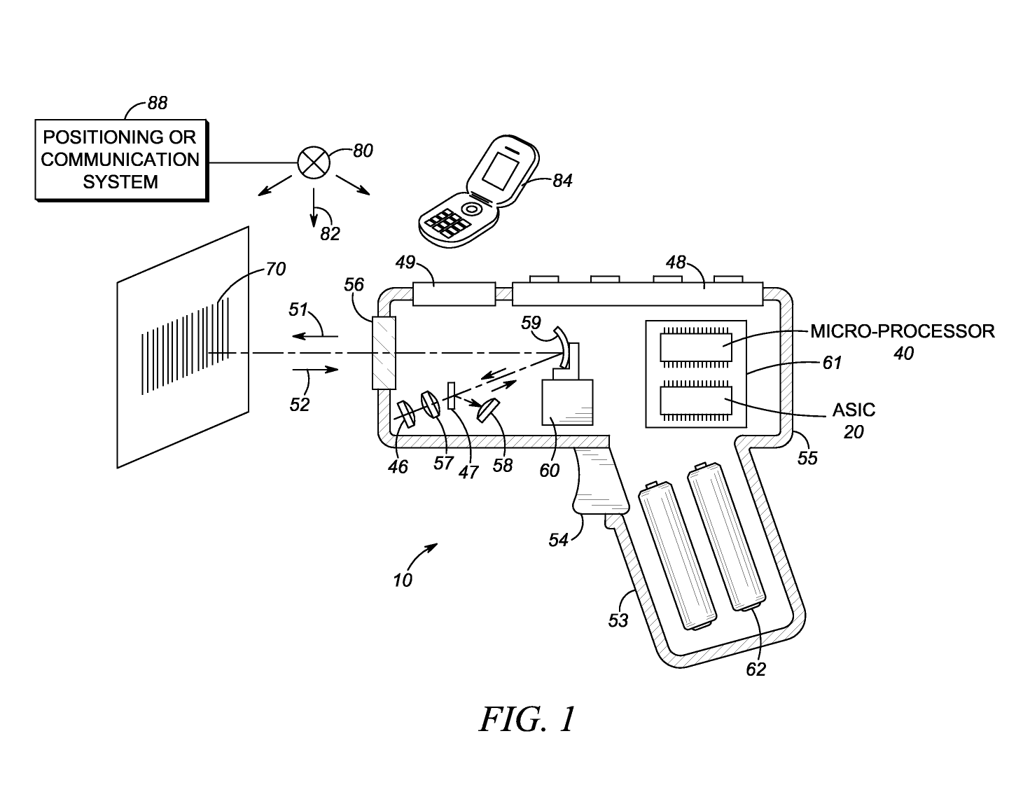

Turning now to the drawings, FIG. 1 depicts a handheld, moving laser beam reader 10 implemented in a gun-shaped housing 55 having a pistol-grip type of handle 53. The housing 55 contains a laser drive or light source 46, preferably a semiconductor laser diode, for emitting an outgoing laser beam 51 having an adjustable output power to a target, such as a bar code symbol 70, for reflection and scattering therefrom; a photodetector 58, preferably a photodiode, for detecting incoming light 52; a focusing optical assembly 57, preferably one or more focusing lenses, for focusing the outgoing laser beam 51 as a beam spot on the symbol 70; an application specific integrated circuit (ASIC) 20 mounted on a printed circuit board (PCB) 61; a programmed microprocessor or controller 40, also preferably mounted on the PCB 61; and a power source or battery 62, preferably mounted in the handle 53. A light-transmissive window 56 at a front end of the housing 55 allows the outgoing laser light beam 51 to exit the housing 55, and the incoming light 52 to enter the housing 55. A user holds the reader 10 by the handle 53, and aims the reader 10 at the symbol 70, preferably at a distance away from the symbol 70. To initiate reading, the user pulls a trigger 54 on the handle 53. The reader 10 may optionally include a keyboard 48 and a display 49 readily accessible to the user.

As further depicted in FIG. 1, the laser beam 51 emitted by the laser light source 46 passes through a partially-silvered mirror 47 to a scan drive component or oscillating scan mirror 59, which is coupled to a drive motor 60, preferably energized when the trigger 54 is manually pulled. The oscillation of the mirror 59 causes the outgoing laser beam 51 to sweep back and forth over a scan angle in a desired scan pattern, e.g., a scan line, across the symbol 70. A variety of mirror and motor configurations can be used to move the laser beam in the desired scan pattern. For example, the mirror 59 need not be a concave mirror as illustrated, but could be a planar mirror that is repetitively and reciprocally driven in alternate circumferential directions over a scan angle about a drive shaft on which the planar mirror is mounted.

As further depicted in FIG. 1, the reader 10 may be operated in a venue, for example, a supermarket, a warehouse, a department store, and the like, and have one or more overhead lighting fixtures 80 and an indoor positioning or communication system 88 operative for accurately locating, or communicating with, one or more mobile devices 84, such as smart phones or cell phones having built-in cameras, which are present in the venue, by pulsing ambient light 82 emitted from the fixtures 80 to transmit an information signal to the phones 84. The information signal is transmitted by digitally pulsing the fixtures 80, i.e., their emitted ambient light is either at a high or maximum brightness (fully turned on), or at a low or minimum brightness (fully extinguished). Each fixture 80 may contain one or more fluorescent lamps or one or more light emitting diodes (LEDs). As described above, the light emitted from the fixtures 80 is operative to both illuminate the venue as ambient light, as well as to transmit an information signal to the cameras in the phones 84 by pulse modulating the light, typically at kilohertz frequencies, to produce pulsed ambient light.

Thus, in this event, the incoming light 52 may have two light components that come from two different sources. The first light component is return laser light derived from the laser light source 46 and is generated by reflection and/or scattering of the laser light beam 51 back by the symbol 70 through the window 56. The second light component is the pulsed ambient light 82 derived from the lighting fixture 80. As shown in FIG. 1, both light components reflect off of the scan mirror 59 and the partially-silvered mirror 47 and impinge on the same detector 58. As described above, there are circumstances where the component due to the pulsed ambient light 82 has a large enough frequency such that it interferes with the component due to the return laser light, and thereby degrades the performance of the reader 10.

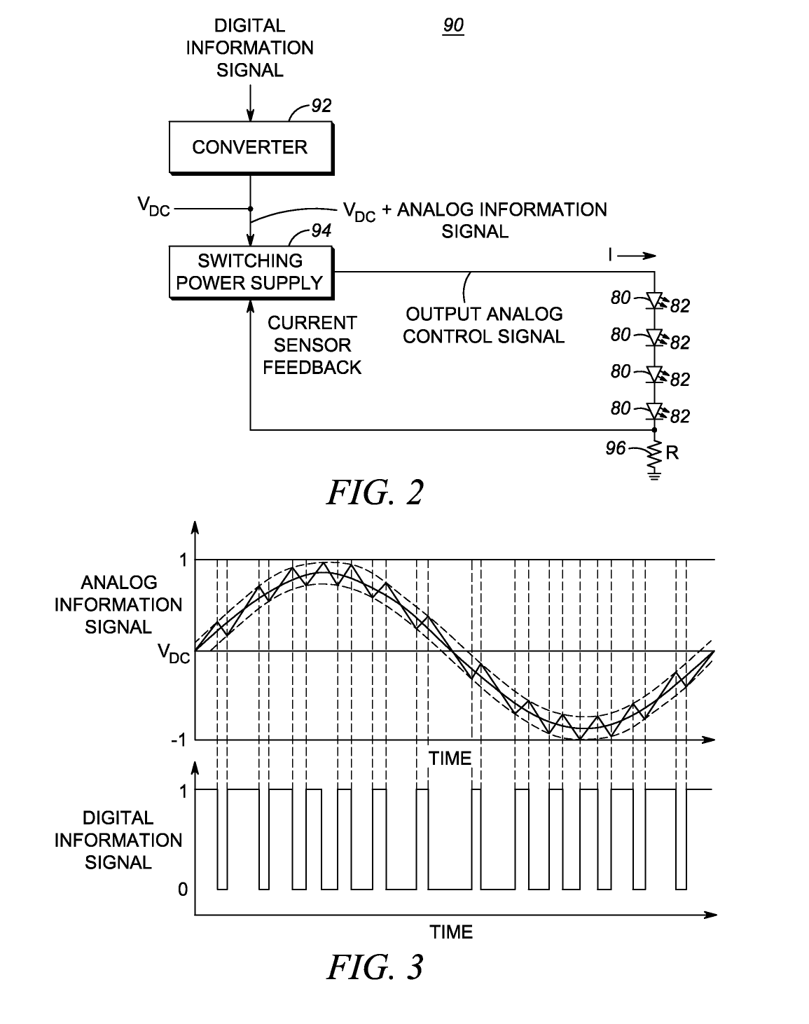

In accordance with this disclosure, it is desired to mitigate such interference by employing the apparatus 90 depicted in FIG. 2, for installation in the positioning/communication system 88. The apparatus 90 includes a converter 92, e.g., a digital to analog converter, for converting a digital information signal (see lower graph of FIG. 3) to an analog information signal (see upper graph of FIG. 3), and a switching power supply 94 operatively connected to the converter 92 and to one or more lighting fixtures 80 (depicted as LEDs) that emit the ambient light 82. The switching power supply 94 receives the analog information signal from the converter 92, generates an output analog control signal from the received analog information signal, and controls the light fixtures 80 with the output analog control signal to emit the ambient light 82 in a time-varying, non-pulsed, analog manner to mitigate interference with the operation of the reader 10.

Advantageously, the switching power supply 94 has an input terminal for receiving the analog information signal and a reference voltage V_{DC}, and the output analog control signal increases and decreases in amplitude relative to the reference voltage V_{DC}. Thus, the ambient light 82 can be set to any desired level of brightness by selecting a desired reference voltage, and the ambient light can vary in brightness relative to the desired brightness level. The output analog control signal is an electrical current (I) that flows to the lighting fixtures 80, and the switching power supply 94 has a feedback terminal for receiving a current feedback signal from a sensor 96 that detects the electrical current flowing to the light fixtures 80.

Thus, in the known art, the fixtures are energized either fully on, or fully off, by repeatedly chopping the electrical current (I). By contrast, in the present disclosure, the fixtures are gradually and continuously energized, that is the electrical current is gradually increased and decreased in amplitude, with a corresponding increase and decrease in ambient light brightness. The signal-to-noise ratio is thereby increased.

In the foregoing specification, specific embodiments have been described. However, one of ordinary skill in the art appreciates that various modifications and changes can be made without departing from the scope of the invention as set forth in the claims below. For example, although the laser-based reader 10 has been illustrated in the drawings, this disclosure can also apply to other data capture devices, such as imager-based readers. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An apparatus for enhancing performance of a data capture device operative for electro-optically reading a target in a venue for transmitting an information signal by pulsing ambient light that interferes with operation of the data capture device, the apparatus comprising:
a converter for converting the information signal to an analog information signal; and
a switching power supply operatively connected to the converter and to a lighting fixture that emits the ambient light, the switching power supply being operative for receiving the analog information signal from the converter, for generating an output analog control signal from the received analog information signal, and for controlling the light fixture with the output analog control signal to emit the ambient light in a time-varying, non-pulsed, analog manner to mitigate interference with the operation of the data capture device.

2. The apparatus of claim 1, wherein the converter includes a digital to analog converter.

3. The apparatus of claim 1, wherein the switching power supply has an input terminal for receiving the analog information signal and a reference voltage, and wherein the output analog control signal increases and decreases in amplitude relative to the reference voltage.

4. The apparatus of claim 1, wherein the output analog control signal is an electrical current that flows to the lighting fixture, and wherein the switching power supply has a feedback terminal for receiving a current feedback signal from a sensor that detects the electrical current flowing to the light fixture.

5. An apparatus for enhancing performance of a laser-based moving beam reader operative for electro-optically reading a target in a venue for transmitting an information signal by pulsing ambient light that interferes with operation of the reader, the apparatus comprising:
a converter for converting the information signal to an analog information signal; and
a switching power supply operatively connected to the converter and to a lighting fixture that emits the ambient light, the switching power supply being operative for receiving the analog information signal from the converter, for generating an output analog control signal from the received analog information signal, and for controlling the light fixture with the output analog control signal to emit the ambient light in a time-varying, non-pulsed, analog manner to mitigate interference with the operation of the reader.

6. The apparatus of claim 5, wherein the converter includes a digital to analog converter.

7. The apparatus of claim 5, wherein the switching power supply has an input terminal for receiving the analog information signal and a reference voltage, and wherein the output analog control signal increases and decreases in amplitude relative to the reference voltage.

8. The apparatus of claim 5, wherein the output analog control signal is an electrical current that flows to the lighting fixture, and wherein the switching power supply has a feedback terminal for receiving a current feedback signal from a sensor that detects the electrical current flowing to the light fixture.

9. A method of enhancing performance of a data capture device operative for electro-optically reading a target in a venue for transmitting an information signal by pulsing ambient light that interferes with operation of the data capture device, the method comprising:
converting the information signal to an analog information signal;
generating an output analog control signal from the analog information signal; and
controlling a light fixture that emits the ambient light with the output analog control signal to emit the ambient light in a time-varying, non-pulsed, analog manner to mitigate interference with the operation of the data capture device.

10. The method of claim 9, wherein the converting is performed from a digital information signal.

11. The method of claim 9, wherein the generating is performed by receiving the analog information signal and a reference voltage, and wherein the output analog control signal increases and decreases in amplitude relative to the reference voltage.

12. The method of claim 9, wherein the output analog control signal is an electrical current that flows to the lighting fixture, and detecting the electrical current flowing to the light fixture, and generating a current feedback signal from the detected current.

13. The method of claim 9, and configuring the data capture device as a laser-based moving beam reader.
